(19) United States
(12) Patent Application Publication
(10) Pub. No.: US 2023/0326370 A1
(43) Pub. Date: Oct. 12, 2023

(54) EDUCATIONAL DICE SYSTEM

(71) Applicant: James Moran, Arlington, VA (US)

(72) Inventor: James Moran, Arlington, VA (US)

(21) Appl. No.: 18/204,408

(22) Filed: Jun. 1, 2023

Related U.S. Application Data
(63) Continuation-in-part of application No. 15/712,505, filed on Sep. 22, 2017, now abandoned.
(60) Provisional application No. 62/398,218, filed on Sep. 22, 2016.

(51) Int. Cl. G09B 23/02; A63F 9/04

(52) U.S. Cl. CPC G09B 23/02; A63F 9/0415; A63F 2009/0437; A63F 2009/0477

(57) ABSTRACT

A math learning process uses a first set of dice and a second set of dice. The process includes configuring the first set of dice and the second set of dice to respectively produce equal probabilities of occurrence of two different sums. A first player rolls the first set of dice and records the sum. A second player rolls the second set of dice and records the sum. These steps are repeated until one of the first player and the second player rolls a particular sum a predetermined number of times. Other dice configurations facilitate focus on specific math facts and operations.

### CROSS-REFERENCES TO RELATED APPLICATIONS

This application is a continuation-in-part of U.S. application Ser. No. 15/712,505, filed Sep. 22, 2017, pending, which claims the benefit of U.S. Provisional Patent Application No. 62/398,218, filed Sep. 22, 2016, the entire contents of both of which are herein incorporated by reference.

### STATEMENT REGARDING FEDERALLY SPONSORED RESEARCH OR DEVELOPMENT

(NOT APPLICABLE)

### BACKGROUND

The invention relates to a system or set of polyhedral gaming devices (commonly known as dice) that include non-traditional number series and combinations of numbers that optimize reinforcement of certain mathematical operations, specifically certain operations associated with more “difficult to learn” number operation combinations or so-called “fact families.”

On traditional dice often used in gaming, ordinal numbers generally include number sets ranging from 1 to the highest number possible given the sides on the solid, with some variations and number repeating on certain designs (e.g., numbers 1-6 appearing twice on a twelve sided die, or numbers 0-9 appearing twice on a twenty-sided die). These designs uniformly produce equally distributed results of combinations of the numbers depicted.

When rolling a common pair of 6-sided dice, rolls that include the number 1 or 2 on at least one side of one of the dice occur over 55% of the time. For young children or other players who have basic number operational math skills, these rolls are extremely simple to add to another number produced on the accompanying die. Such dice are limited in their efficiency in teaching harder to learn sums and products. Consequently, these dice, as well as all other ordinal dice, are limited in their educational value.

There are distinct but varying patterns in the deficiencies of otherwise highly accomplished high school students routinely display on the math sections of standardized timed tests such as the SAT and ACT. Many of these deficiencies can be traced to a failure to commit certain harder to learn “math facts” (certain single digit sums and products) to long-term memory (sometimes commonly interchanged with the concept of achieving “math fact fluency”). Although there are general patterns to the observed deficiencies, there is a significant amount of variation when it comes to the gaps individual students display.

Tests of elementary school age children of varying ages were conducted to observe learning trends and understand more effective ways to develop “math fact fluency.” Understanding that the difficulties students displayed in subtraction and division operations could invariably be traced to a lack of mastery of addition and multiplication math facts, observations were made on understanding the relative success and ease in which both younger elementary and high school students learned and retained math fact fluency and what math facts were persistently problematic for the groups.

### BRIEF SUMMARY

After making these observations, the dice system of the described embodiments was developed that could be used in a wide variety of game applications that would target the persistent hurdles young elementary students face in achieving math fact fluency, many of which are likely to face continued challenges throughout their early education and beyond.

Although the dice system would desirably target the broad array of challenges all students face, preferred designs would be able to adapt to the unique needs of an individual student by effectively and progressively eliminating dice combinations (and their associated math operations in game play) of previously mastered material.

The dice system of the described embodiments has been developed to be used in original games and game play that allow for adaptive use of different combinations of the dice to encourage mastery of specific math operations, depending on the educational skill level of the player. Moreover, this dice system is designed to continually challenge players to increase math proficiency in material typically associated with academic curriculum that spans several years, and its adaptable design is uniquely responsive to the varying ways young children successfully learn, progress through, and master math operations of increasing complexity and achieve so-called “math fact fluency.”

According to the described embodiments, a set of polyhedral game pieces includes number combinations that are universally harder to master (compare addition flash cards that include combinations such as 5+8, or 4+7, versus 5+1 or 2+2, or multiplication flash cards that include number combinations such as 8×6 or 6×7, versus 5×10 or 2×4). In this dice game/system, each dice roll will encourage and build recognition of harder number combinations and will be used in games that can be played with originally developed game content, or incorporated into other games.

In an exemplary embodiment, a math learning process uses a first set of dice and a second set of dice. The math learning process may include the steps of (a) configuring the first set of dice and the second set of dice to respectively produce equal probabilities of occurrence of two different sums, (b) a first player rolling the first set of dice, (c) the first player recording the sum of the first set of dice after step (a), (d) a second player rolling the second set of dice, (e) the second player recording the sum of the second set of dice, and (f) repeating steps (b) through (e) until one of the first player and the second player rolls a particular sum a predetermined number of times.

The first set of dice may be different from the second set of dice. A number distribution on the first set of dice may be different from a number distribution on the second set of dice. The first set of dice may be a different color than the second set of dice.

In another exemplary embodiment, a math learning process uses a four dice set including two dice of a first color and two dice of a second color. The math learning process may include the steps of (a) configuring the four dice set such that a sum of the two dice of the first color when rolled will always match or exceed a sum of the two dice of the second color when rolled, (b) a player rolling the four dice set, (c) the player adding the two dice of the first color and subtracting the two dice of the second color to achieve a running total, and (d) the player repeating step (c) until the running total reaches a predetermined number.

The process may include, after step (c), (c1) a competitor rolling the four set dice, and (c2) the competitor adding the two dice of the first color and subtracting the two dice of the second color to achieve a competing running total. Step (d) may be practiced by repeating steps (c), (c1) and (c2) until one of the running total and the competing running total reaches the predetermined number.

Step (a) may be practiced such that a lowest sum of the two dice of the first color is X and such that a highest sum of the two dice of the second color is X. In some embodiments, X equals eight.

In yet another exemplary embodiment, a set of polyhedral game pieces is suited for reinforcing certain mathematical operations. The polyhedral game pieces each includes a plurality of sides, each of which contains a number. The numbers are selected such that the polyhedral game pieces are configured to eliminate occurrences of level one fact families when rolled and to eliminate or deemphasize level two fact families when rolled.

### BRIEF DESCRIPTION OF THE DRAWINGS

These and other aspects and advantages will be described in detail with reference to the accompanying drawings, in which:

FIG. 1 depicts the twelve sides of a 12-sided polyhedral game piece in a first configuration;

FIG. 2 depicts the twelve sides of a 12-sided polyhedral game piece in a second configuration;

FIG. 3 depicts the twelve sides of a 12-sided polyhedral game piece in a third configuration;

FIGS. 4-6 depict the six sides of a 6-sided polyhedral game piece in various configurations, respectively; and

FIG. 7 depicts the twelve sides of an alternative 12-sided polyhedral game piece with a hybrid configuration.

### DETAILED DESCRIPTION

With reference to the drawings, the dice system of the described embodiments exclude numbers associated with so-called easy to learn “fact families” such as 1, 2, and 10, and can deemphasize (from a probabilistic play perspective) or eliminate certain so-called medium level difficulty “fact family” numbers (for example, numbers 3 and 9 when focusing on mastery of harder to learn addition operations, or the number 5 when focusing on mastery of hard to learn multiplication operations). For purposes of the present description, the easy to learn “fact families” are deemed “level one fact families” and exclude at least the numbers 1 and 2, or the numbers 1, 2 and 10, or the numbers 1, 2, 5 and 10. The excluded number sets may additionally exclude the number 11 and/or the number 12 in some variations. The medium level fact families are deemed “level two fact families” and include the numbers 3 and 9 for game play aimed at teaching mastery of addition fact families, and the number 5 when used in game play emphasizing the mastery of multiplication fact fluency. Under certain constructions, the dice can be configured during play to emphasize a level two fact family number with the same probability of occurrence as any other individual die face number, reduce the probability of occurrence of the number, or eliminate the probability of occurrence all together, depending on the skill level of individual players.

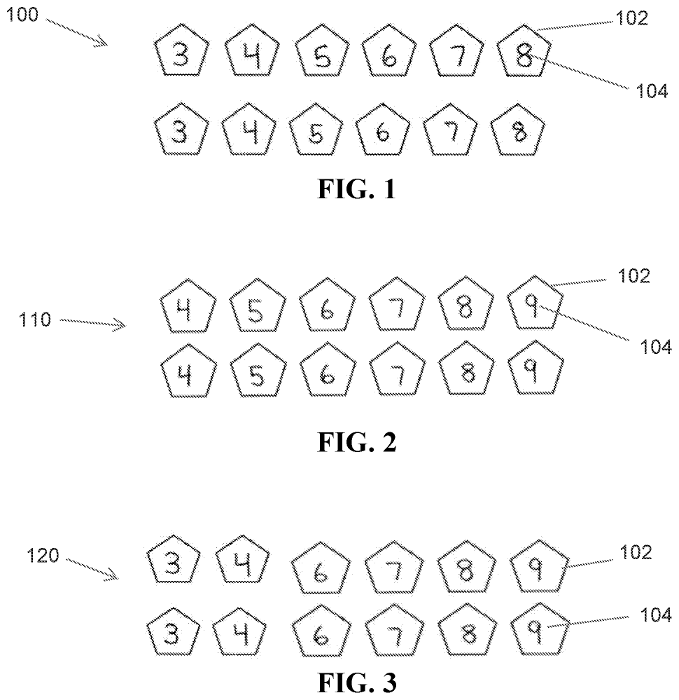

Due to the multiple die construct of the dice system, game play can be adapted to the specific areas of emphasis that would benefit a particular child the most. For example, a child who has already learned how to add sums involving the number 9 more efficiently than the number 3 can adapt sum and number tally games that are played with the dice to exclude dice with 9s (e.g., a “Mean 11” die set 100 as shown in FIG. 1) and emphasize play with the number 3 (the number 3 has equal probability of occurrence as each other face value. Moreover, dice can be combined in different combinations (in pairs or pools) during game play to reinforce mastery of specific math fact families that have not been committed to long-term memory.

A preferred dice design will include common 12-sided and/or 6-sided polyhedral solids. With continued reference to the drawings, each of the polyhedral game pieces includes a plurality of sides 102, each of which contains a number 104. As described above, with the use of non-conventional numbering, the game pieces are configured to eliminate occurrences of the level one fact families when rolled. Similarly, the game pieces may be further configured to reduce or eliminate occurrences of the level two fact families when rolled, by interchanging dice from the respective sets to vary the probabilities of occurrence as desired or directed in game play. The game pieces may be customizable based on desired specific areas of emphasis. In some embodiments, the numbers 104 on the sides 102 of the polyhedral game pieces may be selected such that the polyhedral game pieces are configured to eliminate the occurrences of level one fact families when rolled and also to deemphasize the level two fact families when rolled. For example, first certain specific numbers may be excluded from the game pieces to thereby reduce or eliminate the occurrences of the level one fact families when rolled; and second certain specific numbers, different from the first certain specific numbers, may be limited (e.g., appearing only once on a 12-sided die, or by using a die or dice from different sets in pairs or collective dice pools during play) to thereby vary the occurrences of the level two fact families when rolled.

In some embodiments, the “starter” or “base” set of dice will include 12-sided polyhedral solids that include two 12-sided dice 100 with the number set 3, 4, 5, 6, 7 and 8 as shown in FIG. 1, with each of the aforementioned numbers occurring on two faces respectively on each die (the “Mean 11” die set).

Another set of two 12-sided dice 110 of similar physical construction may include the number set 4, 5, 6, 7, 8 and 9 as shown in FIG. 2 (the “Mean 13” die set). Finally, in some embodiments, a third set of two 12-sided dice 120 of similar physical construction will include the number set 3, 4, 6, 7, 8 and 9 (the “Multi-Dice” die set). The sets of dice may include any of various combinations of dice including, without limitation, a set of four dice including two of the “Mean 11” die set and two of the “Mean 13” die set, or a set of six dice in combinations.

In some embodiments, the dice may be color coded. For example, the Mean 11 Dice 100 shown in FIG. 1 may have blue numbers, the Mean 13 Dice 110 shown in FIG. 2 may have red numbers, and the Multi-Dice 120 shown in FIG. 3 may have green numbers. Color-coding on subsequent versions could include different variations, but it is desirable to ensure the three sets of dice in the system have distinct color codes. The color coding allows for easy reference during game play and also encourages players to develop and master certain pre-algebra skills as well as fundamentals of probability distribution while playing games that reward certain strategic approaches, throughout a spectrum of games. In practical applications and testing activity, it was discovered that kids are better able to differentiate and index numbers with four dice when two of the dice are one color and two of the dice are a different color.

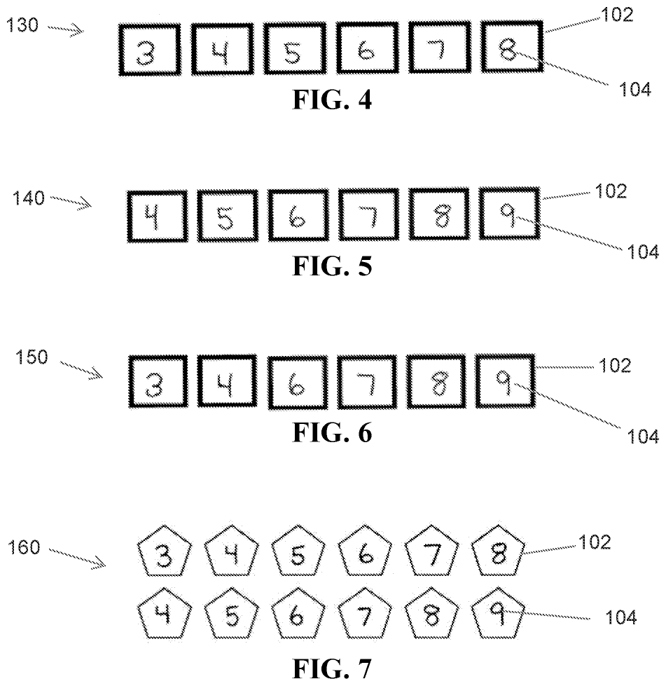

With reference to FIGS. 4-6, the dice sets can also be manufactured using 6-sided die cubes. The “Mean 11” 6-sided die 130 is shown in FIG. 4; the “Mean 13” 6-sided die 140 is shown in FIG. 5; and the “Multi-die” 6-sided die 150 is shown in FIG. 6.

From many perspectives, 12-sided dice demonstrate more control when rolling, making speed dice games more enjoyable.

Each side on all dice will have a roughly equal chance of occurring on rolls. In an alternative construction, a size of the sides or polyhedral weighting may vary to avoid or reduce the occurrences of “level one fact families” or “level two fact families” when rolled. The system/dice may include any distribution of the aforementioned numbers on similar die or dice sets. The dice may include Arabic or other recognized numeral representations, as well as symbols that would depict the desired numbers displayed (such as dots or “pips” with the associated number of dots or “pips” appearing on the face, polygon shapes with the corresponding number of sides and corners, dots or “pips” in patterns, or other markings that clearly denote the desired numbers).

In some embodiments, with reference to FIG. 7, a “hybrid” 12-sided die 160 with the numbers occurring on die faces may be provided. In this embodiment, the numbers 3 and 9 may occur only once, with all other numbers occurring twice. In the hybrid construct, the occurrence of certain number combinations that sum to the high and low ends of the distribution of expected roll results is slightly different, which allows for novel variations in game play strategy when used in certain games.

Exemplary Games: Although the dice will be applicable to countless game variations, it is contemplated that each initial dice set may include a set of game rules for certain base games that can be played alone, without inclusion in a larger or more elaborate game (like a board game, table-top game, or role-playing game). As would be appreciated by those of ordinary skill in the art, these “base games” and their concepts could, however, be incorporated into such elaborate games, or the dice could be used in new or similar ways.

Exemplary Base Game 1: Lucky 11 Vs. Mean 13:

(Basic level game that optimizes learning of addition of harder to learn single digit sums, number sense, probability distribution)

One player rolls a Mean 11 Dice Set, hoping for a sum of 11; the other player rolls a Mean 13 Dice Set, trying for a sum of 13. First player to hit their number wins. Multiple rounds can be played to determine a best-of-series winner; the loser of a previous round rolls first in the next round.

Exemplary Base Game 2: Add Two, Takeaway Blue:

(Basic to intermediate level game that optimizes addition and subtraction of harder sums/differences, number sense, larger number addition and tallying)

Players roll a Mean 13 Dice Set and one Mean 11 Die, adding the two Mean 13 Dice and subtracting the Mean 11 die. Players alternate turns and the first to 100 (or more) wins.

Exemplary Base Game 3: Double Done 151:

(Basic to intermediate level game that optimizes addition of harder sums, larger number addition, multiples of 25, number sense, probability distribution)

A strategy game where players alternate turns rolling one Mean 11 die and one Mean 13 die (referred to as a “Mean 12” die set), adding the dice and tallying consecutive rolls (like many games, this game can also be played with different dice combinations depending on the learning needs of the player). The first player to total of 151 (or more) wins. A player can roll as many times as he or she wants on any turn, but double number rolls (e.g. 7 and 7) can wipe-out a player's total tally to zero and end the player's turn. Players can choose to freeze their running tally immediately after reaching an amount equal to or above any increment/multiple of 25 (i.e. 25, 50, 75, 100, 125, 150) by relinquishing their turn. This ensures any future wipe-outs only go back to the multiple 25/increment number where the player froze. After freezing at any number, the player's next turn starts at the tally achieved before freezing (not necessarily the increment of 25). Also, when a player starts from zero, he or she must keep rolling until reaching a tally of at least 25 (first opportunity to freeze), and a player cannot freeze at the same number he or she froze at the turn before (must get to at least one increment of 25 higher).

Exemplary Base Game 4: Score 24!:

(Intermediate game that optimizes addition of harder sums, number sense, larger number addition, probability distribution, pre-algebra skills)

Players alternate rolling four dice (Mean 11 and Mean 13 sets) in an attempt to get a sum of 24. Players can re-roll any number of dice—up to four times— and keep any die/dice results after any roll. All die faces must be added. Earn points as follows:
24 on 1 roll: 5 points
24 on 2 rolls: 4 points
24 on 3 rolls: 3 points
24 on 4 rolls: 2 points

Score of 23 or 25 (any number of rolls up to 4): 1 point (player relinquishes turn after taking this point if all four rolls not taken)

Score of 24 with 4 sixes (any number of rolls up to 4): 6 points

Failure to achieve an above result: 0 points

First player to a tally of 24 (or more) points from roll scores wins.

Exemplary Base Game 5: Prime Time:

(Advanced game that promotes mastery of harder to learn addition, subtraction, multiplication, larger number addition, number sense, probability, prime number recognition)

This advanced game for older players also uses four dice (selected die sets could utilize Multi-Dice for players who have mastered times tables involving 5s). The object is to get the highest prime number result (for prime numbers between 1-100) by performing addition, subtraction, multiplication or division using each of the numbers taken from a player's final roll results (each number is only used once-see scoring example below). All four dice are rolled on the first roll, and a player can choose to roll any number of dice on up to three more rolls, or keep any or all die result(s) after any roll before that. Players can use the 1-100 prime number chart to target certain numbers while calculating possibilities on the given die faces. Players alternate turns and tally consecutive prime number results after each turn. The first player to tally 1,000 wins. Final roll totals equaling a prime number between 1-10 (2, 3, 5 and 7) earns a total of 10 points for the round. All other prime numbers achieved are worth their face value. Use timers between rolls for more advanced players or to quicken play. Use the prime number table to help with targeting numbers.

Scoring example: final die face numbers 5, 6, 8 and 9 could equal a maximum score of 83 by multiplying 8 and 9 (equals 72) and adding 6 plus 5 (equals 11), for a final prime result of 83. A player could also score other prime numbers with these results, but can only credit one result to his or her tally.

Playsheets, Gamebooks, and other games: The dice system is also usable in a number of original games and playsheets specifically designed to emphasize varying levels of math skills, through the use of various unique combinations of the dice in the base pack.

In addition to the advantages of previously stated claims regarding the preferred number results that the dice produce in relation to teaching basic math skills, specific manifestation of improved game play can include a variety of superior educational outcomes.

In games where a one player rolls a Mean 11 Set and the other rolls a Mean 13 set, such as Lucky 11 vs. Mean 13, players can be rewarded points for achieving the most frequently occurring sum of the respective dice sets (11 or 13). The varied numbers on the distinctly colored dice sets allow for easy to learn instruction for younger players, and the dice produce equal probabilities of occurrence of two different sums, respectively. This has the effect of making the players continually differentiate between harder to learn sums (10, 11, 12, 13, 14, 15 etc. without easier fact family combinations involving 1, 2 10, 11, etc.), which are produced at much higher frequency than regular “ordinal dice.” The different distribution of the results on each set also optimizes the span of the number sum results each player considers during game play, as the sum results of an opponent's roll is just as important in game play as a player's own roll vis-à-vis an ultimate winning outcome, which is determined when a certain number of sums have been achieved by one player first.

The 4-dice set manifestation also allows for easy-to-follow rules for games that optimize teaching addition and subtraction, such as in the game “Add Two Take Away Blue.” In this case, players add two red Mean 13 Dice and subtract the blue die and add to a running total. Because of the unique number constructs on the different dice, it not only produces optimized sum results that are vastly more preferred than regular ordinal dice, but also eliminates the possibility of negative number results (values below zero) after a subtraction calculation is performed on the sum of the red Mean 11 Dice. In other words, the lowest sum of the two red Mean 13 Dice may be configured to be 8 (4+4) (or some other number), and the highest number produced by the blue Mean 11 die may also be 8 (or that same other number), which would result in a 0 roll score, e.g. 4+4-8=0. This construct is preferred for many age groups as it avoids potential negative number results, which is a more advanced math concept for the early learners these dice are designed to help. Moreover, this construct forces the occurrence of a wider-span of difficult sum and subtraction outcomes than ordinal dice allow for, which if used in a similar game would have to have a rule that required adding of “two highest” dice and subtraction of a lower number, which would result in a narrowed set of math facts that are not preferable.

The 4-dice construct of 25 MM dice is also preferable for dice-pool games involving a player using all four dice to perform addition, subtraction, multiplication, division, and more advanced operations, as appropriate. In games where all four dice are used, such and tic-tac-toe games where players must use various operations to achieve results on a tic-tac-toe grid, the number results of the dice and calculated results on a game grid can be designed to emphasize more desired math fact results, which would not be as efficient as four regular ordinal dice. That is, the numbers on the dice product the math facts, and the dice may be configured to achieve specific math fact results. For example, with a grid game where the players are trying to master a seven (“7”) multiplication table, the grid may include numbers as 21, 28, 35, 42, 49, etc. The dice can be configured to emphasized the ×7 results so the players use these math facts more frequently and the game is played more efficiently.

The size of the dice can fit in a carrying bag that will fit in the pocket or hand of the intended audience (ages 6 and up) and has larger outsized numeric numbers that are easy to see and manipulate. The color coding of the different dice sets also allows for easier to understand directions for game play which can be understood by the learning audience.

The six dice construct in Board and Table Games may utilize two blue Mean 11 Dice, two red Mean 13 Dice, and two red and blue (or green) Multi-Dice. In addition to the advantages of the four dice system, the addition of the Multi-Dice to the six dice system allows for advanced game play which optimizes the focused learning of multiplication facts, as the dice eliminate the number 5, which deemphasizes these math facts when used with two of the other game dice in a four dice, dice pool game. The system allows for extended learning opportunities for young players, as it provides a game that can be played in two different ways—one version involving addition and one as a multiplication game, which are both optimized for the respective math operation being targeted. Moreover, the dice system allows for measurable learning objectives when used in games that require the targeting of all sum combinations, as they are expected to be distributed though game play that is of appropriate length for the intended age group, namely ages 8 and up. This is to say that when the player(s) can complete game play in the addition game version in 30-35 minutes (established as appropriate for the attention span of the age group), they have generally been observed to be “math fact fluent” with addition facts and ready to play the game with extremely similar game play with multiplication, which change two of the four dice in the dice pool. For example, to change to the multiplication learning play, one of the Mean 11 Dice and one of the Mean 13 Dice are removed and replaced with two dice from the Multi-Dice set. Here, the efficiency of the dice system serves to optimize learning within a specifically desired game length, which is optimized for both learning and entertainment.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A math learning process using a first set of dice and a second set of dice, the math learning process comprising:
(a) configuring the first set of dice and the second set of dice to respectively produce equal probabilities of occurrence of two different sums;
(b) a first player rolling the first set of dice;
(c) the first player recording the sum of the first set of dice after step (a);
(d) a second player rolling the second set of dice;
(e) the second player recording the sum of the second set of dice; and
(f) repeating steps (b) through (e) until one of the first player and the second player rolls a particular sum a predetermined number of times.

2. A math learning process according to claim 1, wherein the first set of dice is different from the second set of dice.

3. A math learning process according to claim 2, wherein a number distribution on the first set of dice is different from a number distribution on the second set of dice.

4. A math learning process according to claim 2, wherein the first set of dice is a different color than the second set of dice.

5. A math learning process using a four dice set including two dice of a first color and two dice of a second color, the math learning process comprising:
(a) configuring the four dice set such that a sum of the two dice of the first color when rolled will always match or exceed a sum of the two dice of the second color when rolled;
(b) a player rolling the four dice set;
(c) the player adding the two dice of the first color and subtracting the two dice of the second color to achieve a running total; and
(d) the player repeating step (c) until the running total reaches a predetermined number.

6. A math learning process according to claim 5, further comprising, after step (c):
(c1) a competitor rolling the four set dice; and
(c2) the competitor adding the two dice of the first color and subtracting the two dice of the second color to achieve a competing running total,
wherein step (d) is practiced by repeating steps (c), (c1) and (c2) until one of the running total and the competing running total reaches the predetermined number.

7. A math learning process according to claim 5, wherein step (a) is practiced such that a lowest sum of the two dice of the first color is X and such that a highest sum of the two dice of the second color is X.

8. A math learning process according to claim 7, wherein step (a) is practiced such that X equals eight.

9. A math learning system comprising:
a set of polyhedral game pieces suited for reinforcing certain mathematical operations, the polyhedral game pieces each including a plurality of sides, each of which contains a number,
wherein the set of polyhedral game pieces is configured for learning games involving addition and learning games involving multiplication,
wherein the set of polyhedral game pieces is configured to allow for measurable learning objectives when used in learning games that require targeting of all sum combinations, as they are expected to be distributed though learning play that is of appropriate length for an intended age group, such that when a participant can complete learning play in the learning game involving addition in 30-35 minutes, the participant is ready to participate in the learning game involving multiplication, and
wherein the set of polyhedral game pieces is configured to optimize learning within a specifically desired learning game length.

10. A math learning system according to claim 9, wherein the numbers are selected such that the polyhedral game pieces are configured to eliminate occurrences of level one fact families when rolled and to eliminate or deemphasize level two fact families when rolled.

11. A math learning system according to claim 9, wherein for the learning game involving multiplication, two of the four dice in the dice pool are changed for dice with different numbers that are more suitable for multiplication exercises.
